(19) United States
(12) Patent Application Publication
(10) Pub. No.: US 2025/0218180 A1
(43) Pub. Date: Jul. 3, 2025

(54) A METHOD OF LOCATING A VEHICLE AND RELATED SYSTEM

(71) Applicant: ALBA ROBOT S.R.L., Torino (IT)

(72) Inventor: Andrea BERTAIA, Torino (TO) (IT)

(21) Appl. No.: 18/850,878

(22) PCT Filed: Mar. 30, 2023
(86) PCT No.: PCT/IB2023/053168

§ 371 Date: Sep. 25, 2024

(30) Foreign Application Priority Data
Mar. 30, 2022 (IT) 102022000006230

(51) Int. Cl. G06V 20/52; G06K 7/14; G06T 7/73; G06V 10/36; G06V 20/60

(52) U.S. Cl. CPC G06V 20/52; G06K 7/1417; G06T 7/73; G06V 10/36; G06V 20/60; G06T 2207/20081; G06T 2207/30232

(57) ABSTRACT

Described herein are solutions for locating a vehicle (1a) in an environment through a plurality of surveillance cameras (2) installed in the environment. The vehicle (1a) comprises a plurality of sensors (50) configured to detect data (S2) that identify a displacement of the vehicle (1a), and the vehicle (1a) estimates a position (POS′) of an odometry centre (OC) of the vehicle (1a) via odometry as a function of the data (S2) that identify the displacement of the vehicle (1a). A plurality of visual patterns (P) are applied to the vehicle (1a). During a learning phase (1100), a processor (3a) receives a map (300) of the environment and, for each camera (2), an image (306) acquired by the respective camera (2). Next, the processor (3a) generates data (308) that enable association of a pixel of a floor/ground (310) in the image (306) to respective co-ordinates in the map (300). During a localization phase (1200), the processor (3a) repeats (1206, 1210) a sequence of steps for at least one of the surveillance cameras (2). In particular, the processor (3a) receives (1250) an obfuscated image (312) from the camera (2) and checks whether the obfuscated image (312) presents one or more of the visual patterns (P) applied to the vehicle (1a). In the case where the obfuscated image (312) presents one or more of the visual patterns (P), the processor (3a) calculates (1252) the position of an odometry centre (OC) in the obfuscated image (312) as a function of the positions and optionally of the dimensions of the visual patterns (P) appearing in the obfuscated image (312). Next, the processor (3a) determines (1254) a position (POS) of the odometry centre (OC) in the map (300) by mapping the position in the obfuscated image (312) into coordinates in the map (300), using the data (308) that enable association of a pixel of a floor/ground (310) in the image (306) to respective co-ordinates in the map (300). Finally, the processor (3a) sends (1212) the position (POS) of the odometry centre (OC) in the map (300) to the vehicle (a), and the vehicle (1a) sets the estimated position (POS′) of the odometry centre (OC) at the position (POS) received.

### TEXT OF THE DESCRIPTION

### Field of the invention

The present disclosure relates to solutions for locating a vehicle, for example a personal-mobility vehicle or some other type of automated-guided vehicle (AGV), such as an autonomous mobile robot (AMR), in an environment, for instance an airport, a railway station, a hospital, or a shopping mall.

### Description of the prior art

Known to the art are numerous types of personal-mobility vehicles (PMVs). A sub-group of these PMVs are electric vehicles that enable a person with disabilities and/or motor difficulties, the so-called vehicles for persons with reduced mobility (PRMs), such as a disabled or elderly person, to move more easily. For instance, this group of vehicles comprises wheelchairs with electric propulsion means, electric wheelchairs, or electric scooters.

Typically, these PMVs comprise a seat for a user/passenger and a plurality of wheels 40. Typically, the PMV comprises (at least) four wheels, but also known are vehicles that comprise only three wheels or self-balancing electric wheelchairs that comprise only two axial wheels (similar to a hoverboard).

As illustrated in FIG. 1, typically such a vehicle 1 comprises a plurality of actuators 30, typically motors, which enable displacement of the vehicle 1. For instance, these actuators 30 may comprise (at least) two electric actuators 30a and 30b configured to turn, respectively, a first wheel 40a and a second wheel 40b of the vehicle 1. For instance, with reference to a wheelchair, the wheels 40a and 40b are typically the rear wheels. For instance, the actuators 30a and 30b may be motors configured to turn the shaft/hub of the respective wheel 40a or 40b. However, also known are solutions in which the actuators 30a and 30b are in contact with the rims or the tyres of the wheels 40a and 40b. For instance, this latter solution is frequently used in so-called mounting kits that enable conversion of a traditional wheelchair into an electric wheelchair. For instance, for this purpose, there may be cited the Mexican patent application MX2017005757, or the “Light Drive” propulsion system (http://progettiamoautonomia.it/prodotto/propulsione-per-carrozzina-light-drive). In this case, the directional movement of the vehicle 1 is hence obtained via a different rotation of the wheels 40a and 40b. In general, the actuators 30 may also comprise one or more motors for moving the vehicle 1 forwards or backwards, and an additional auxiliary motor that enables steering of the vehicle 1.

The vehicle 1 further comprises a control circuit 20 and a user interface 10. In particular, the control circuit 20 is configured to drive the electric actuators 30 as a function of one or more control signals received from the user interface 10. For instance, the user interface 10 may comprise a joystick, a touchscreen, or some other human-computer interface (HCI), such as an eye-tracker, i.e., an oculometry device (i.e., a device for eye monitoring/eye tracking), or a head-tracking device, i.e., a device for monitoring the position and/or displacement of the head of a user. In particular, the user interface 10 is configured to supply a signal S1 that identifies a direction of movement and possibly a speed of movement. The control unit 20 hence receives the signal S1 from the user interface 10 and converts the signal into driving signals for the electric actuators 30.

FIG. 2 shows an example of an assisted-driving or autonomous-driving PMV. For instance, solutions of this type are described in the documents U.S. Pat. No. 10,052,246 B2, US 2004/0006422 A1 or PCT/IB2022/050108, which are incorporated herein for reference.

In particular, in the case of an assisted-driving PMV, the control signal S1 is not supplied directly to the control circuit 20, but to a processing circuit 60, which is configured to supply a signal, possibly modified, S1′ to the control circuit. Instead, in an autonomous-driving PMV, the processing circuit 60 generates the signal S1′ directly. Consequently, in both cases, the control circuit 20 is configured to generate the driving signals D for the actuators 30 as a function of the signal S1′.

In particular, in many applications, a PMV also comprises a navigation system. Typically, with reference to assisted-driving or autonomous-driving vehicles, a distinction is made between a global route for reaching a given destination and a local route used for avoiding obstacles, such as pedestrians. For instance, with reference to planning of the global route, the processing system 60 may have, associated to it, a communication interface 64 to communicate with a remote server 3, which has, stored within it, a map of the environment in which the vehicle 1 moves. For instance, the communication interface 64 may comprise at least one of the following:
a WiFi interface in accordance with the IEEE 802.11 standard;
a mobile-network transceiver, such as a transceiver for GSM (Global System for Mobile Communications), CDMA (Code-Division Multiple Access), W-CDMA (Wideband Code-Division Multiple Access), UMTS (Universal Mobile Telecommunications System), HSPA (High-Speed Packet Access), and/or LTE (Long-Term Evolution); and
any other bidirectional radio-communication interface designed to transmit digital and/or analog signals.

In general, at least a part of the map of the environment in which the vehicle 1 is moving may be stored also within a memory 62 of the processing circuit 60 or at least associated to the processing circuit 60. In addition, instead of storing a map, the server and/or the memory 62 may also store directly a plurality of routes between different destinations.

Consequently, in many applications, the processing circuit 60 has, associated to it, one or more sensors 50 that make it possible to determine the position of the vehicle 1. For instance, with reference to an outdoor environment, the sensors 50 typically comprise a satellite-navigation receiver 500, for example, a GPS, GALILEO, and/or GLONASS receiver. However, in an indoor environment, the satellite signals are frequently not available. Consequently, in this case, the sensors 50 typically comprise sensors that supply data S2 that can be used for odometry, i.e., for estimating the position of the vehicle 1 on the basis of information of displacement of the vehicle 1. For instance, these sensors 50 may comprise at least one of the following:
sensors that enable measurement of the space covered by some of the wheels 40, for example, encoders 52a and 52b configured to supply signals S2a and S2b that identify the revolutions of the actuators 30a and 30b and/or the rotations of the wheels 40a and 40b;
a sensor 502, for example, a magnetic compass and/or an encoder, for detecting the orientation of the vehicle and/or the steering angle of the vehicle 1a;
a triaxial accelerometer and/or gyroscope 504 configured to detect the axial and/or angular accelerations of the vehicle 1a; and
one or more cameras 506 configured to supply a sequence of images that can be used for a so-called visual odometry.

However, frequently the position obtained via odometry is not very precise, in particular after long periods, because errors in the measurement of the displacement of the vehicle 1 accumulate. Hence, typically, the position of the vehicle 1 should be recalibrated using information that identifies an absolute position of the vehicle 1. Similar problems arise also for other types of autonomous-driving vehicles 1, such as AMR vehicles.

For instance, in an outdoor environment the satellite-navigation receiver 502 can be used for this purpose. Instead, in an indoor environment (but the same solution could be used also out of doors), the sensors 50 may comprise a wireless receiver 508 configured to determine the distance of the vehicle 1 from a plurality of mobile communication radio transmitters installed in known positions, for example, as a function of the power of the mobile communication radio signal, which can be used for a triangulation. Additionally or alternatively, one or more cameras 506 installed on the vehicle 1 may be used for detecting the distance of the vehicle 1 from characteristic objects, where the positions of the characteristic objects are known, and stored, for example, in the server 3 and/or the memory 62, for example, together with the data of the maps.

The above solutions hence require installation of additional mobile communication radio transmitters, and/or provision and learning of visual features, for a subsequent calibration of the position of the vehicle 1. Consequently, these solutions are frequently not easy to use and costly, in particular in the case where just a few vehicles 1 circulate in a wide indoor environment, such as an airport, a railway station, a hospital, or a shopping mall.

As mentioned previously, to plan the local route, the sensors 50 may comprise also sensors 510 for detecting possible obstacles, which enables the processing circuit 60 to implement a local planning of the route by carrying out a (local) mapping of the environment surrounding the vehicle 1. For instance, the sensors 510 may include a SONAR (Sound Navigation and Ranging) system, comprising, for example, one or more ultrasonic transceivers, and/or a LiDAR (Light Detection and Ranging) system. Consequently, also these data may be used for identifying the absolute position of the vehicle 1, for example, by comparing the mapping data with the data stored in the memory 62 and/or in the remote server 3. However, in environments that undergo changes, in particular in crowded environments, these data cannot be used easily to determine the absolute position of the vehicle 1.

### OBJECT AND SUMMARY

The object of the present disclosure is to provide solutions that make it possible to determine the position of a vehicle, such as an assisted-driving or autonomous-driving PMV.

In order to achieve the above object, the subject of the invention is a method for determining the position of a vehicle presenting the characteristics specified in the annexed claim 1. The invention also regards a corresponding locating system.

The claims form an integral part of the teaching provided herein in relation to the invention.

As mentioned previously, various embodiments of the present disclosure regard solutions for locating a vehicle, such as a personal-mobility vehicle, an automated-guided vehicle, or an autonomous mobile robot, in an environment. In particular, in various embodiments, the vehicle is located using a plurality of surveillance cameras installed in the environment.

In various embodiments, the vehicle comprises a plurality of sensors configured to detect data that identify a displacement of the vehicle, wherein the vehicle is configured to estimate a position of an odometry centre of the vehicle via odometry as a function of the data that identify a displacement of the vehicle. Moreover, a plurality of visual patterns are applied to the vehicle.

During a learning phase, a processor receives a map of the environment and for each camera an image acquired by the respective camera. Next, the processor generates data that enable association of a pixel of a floor/ground in the image to respective co-ordinates in the map. For instance, for this purpose, the processor can pre-process the image by means of an edge-detection/edge-extraction algorithm and identify a floor/ground in the image using the pre-processed image.

During a localization phase, the processor performs a sequence of operations for at least one of the surveillance cameras. For instance, in various embodiments, the processor receives, for each camera, respective co-ordinates in the map and the estimated position of the vehicle. Consequently, the processor can select a sub-set of cameras as a function of the estimated position of the vehicle and the co-ordinates of the cameras and receive the obfuscated images of the cameras of the sub-set of cameras.

In particular, in various embodiments, the processor receives an obfuscated image from the camera and checks whether the obfuscated image presents one or more of the visual patterns applied to the vehicle. For instance, the patterns may have one or more predetermined colours, and the obfuscated image may be obtained by means of a filtering operation that keeps only the one or more predetermined colours.

In the case where the obfuscated image presents one or more of the visual patterns applied to the vehicle, the processor computes the position of an odometry centre in the obfuscated image as a function of the positions and optionally of the dimensions of the visual patterns appearing in the obfuscated image. Next, the processor determines a position of the odometry centre in the map by mapping the position of the odometry centre in the obfuscated image into co-ordinates in the map, using the data that enable association of a pixel of a floor/ground in the image to respective co-ordinates in the map.

Finally, the processor sends the position of the odometry centre in the map to the vehicle, where the vehicle is configured for setting the estimated position of the odometry centre at the position received.

In various embodiments, a plurality of vehicles can circulate in the environment. In this case, each vehicle may comprise a combination of univocal patterns. In this case, the processor can thus store data that associate a combination of univocal patterns to a respective vehicle identified via a respective univocal vehicle code. Consequently, in the case where the obfuscated image presents one or more of the visual patterns, the processor can determine the univocal vehicle code associated to the respective combination of patterns and send the position of the odometry centre in the map to the vehicle identified via the univocal vehicle code. For instance, each combination of univocal patterns may comprise patterns with different shapes and/or colours. For instance, in various embodiments, the patterns may comprise a two-dimensional bar code, such as a QR code, where the two-dimensional bar code identifies the respective univocal vehicle code.

Additionally or alternatively, each vehicle may include a dynamic pattern comprising a plurality of indicators. In this case, the processor can receive the estimated positions of the vehicles, determine a sub-set of vehicles that are located nearby, and configure the dynamic pattern of each vehicle of the sub-set of vehicles in such a way as to switch on a different combination of the indicators for each vehicle of the sub-set of vehicles. Consequently, in this case, the processor can store data that associate to the estimated position and to the combination of the indicators of each vehicle of the sub-set of vehicles a respective vehicle identified via a univocal vehicle code. Hence, in the case where the obfuscated image presents one or more of the visual patterns, the processor can compare, for each vehicle of the sub-set of vehicles, the respective estimated position with the given position and the detected combination of patterns with the combination of the indicators in such a way as to select a vehicle of the sub-set of vehicles and send the position of the odometry centre in the map to the vehicle selected.

### BRIEF DESCRIPTION OF THE DRAWINGS

Embodiments of the present disclosure will now be described in detail with reference to the attached drawings, which are provided purely by way of non-limiting example and in which:

FIG. 1 shows a block diagram of a personal-mobility electric vehicle;

FIG. 2 shows a block diagram of an assisted-driving or autonomous-diving electric vehicle;

FIG. 3 shows a first embodiment of a system for locating a vehicle;

FIG. 4 shows a second embodiment of a system for locating a vehicle;

FIG. 5 is a flowchart that shows an embodiment of operation of the system of FIG. 4;

FIG. 6 is a flowchart that shows an embodiment of a learning step of FIG. 5;

FIG. 7 shows an example of a portion of a map;

FIG. 8 shows an example of an image that frames the portion of the map of FIG. 7;

FIGS. 9 and 10 show examples of pre-processed images;

FIGS. 11 and 12 are flowcharts that show embodiments of a locating step of FIG. 5;

FIG. 13 is a flowchart that shows an embodiment of a step of processing of an obfuscated image of FIG. 11 or FIG. 12;

FIGS. 14A and 14B show an example of a vehicle that comprises a plurality of predetermined patterns;

FIG. 15A shows an example of the image of FIG. 8 that comprises the vehicle of FIG. 14A;

FIG. 15B shows an example of an obfuscated version of the image of FIG. 15A;

FIGS. 16A-16E show examples of the position of an odometry centre of the vehicle illustrated in FIGS. 14A and 14B;

FIG. 17 shows an embodiment for computing the position of the odometry centre of the vehicle in FIG. 15B; and

FIG. 18 shows an embodiment of a dynamic pattern.

### DETAILED DESCRIPTION OF EMBODIMENTS

In the ensuing description, various specific details are illustrated aimed at enabling an in-depth understanding of the embodiments. The embodiments may be obtained without one or more of the specific details, or with other methods, components, materials, etc. In other cases, known structures, materials, or operations are not illustrated or described in detail so that various aspects of the embodiments will not be obscured.

Reference to “an embodiment” or “one embodiment” in the framework of the present description is intended to indicate that a particular configuration, structure, or characteristic described in relation to the embodiment is comprised in at least one embodiment. Hence, phrases such as “in an embodiment” or “in one embodiment” that may be present in different points of the present description do not necessarily refer to one and the same embodiment. Moreover, particular conformations, structures, or characteristics may be combined in any adequate way in one or more embodiments.

The references used herein are provided merely for convenience and hence do not define the sphere of protection or the scope of the embodiments.

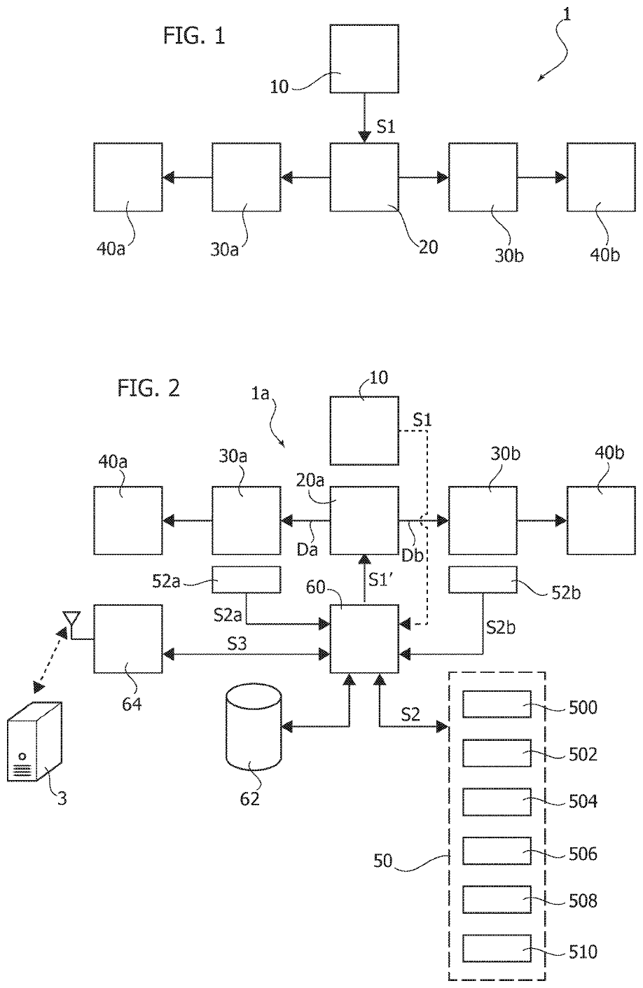

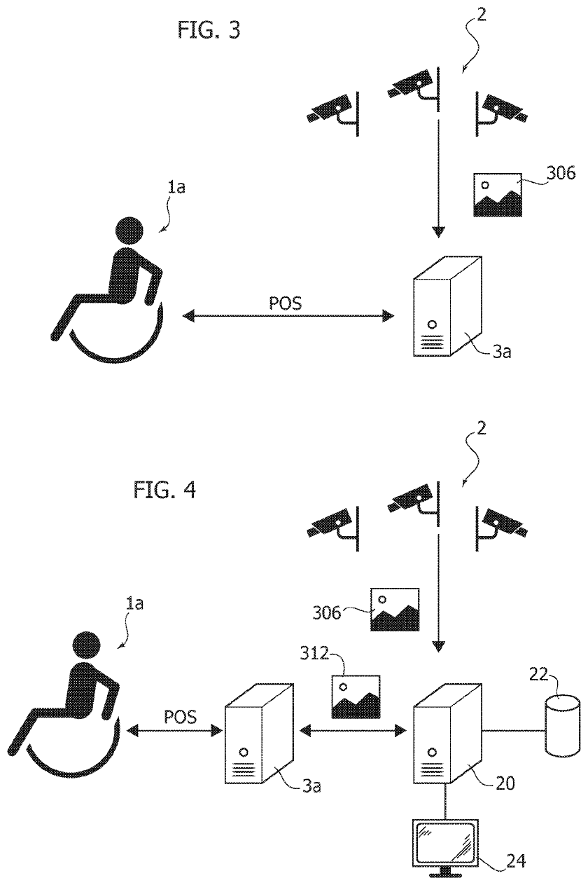

In the following FIGS. 3 to 17, the parts, elements, or components that have already been described with reference to FIGS. 1 and 2 are designated by the same references as those used previously in those figures. The description of these elements described previously will not be repeated hereinafter in order not to overburden the present detailed description.

As mentioned previously, the present disclosure provides solutions for determining the position of a vehicle, such as a PMV or an AMR. In general, this position may be absolute (for example, expressed in terms of latitude and longitude) or relative with respect to a map (for example, expressed with cartesian co-ordinates with respect to the map).

FIG. 3 shows a first embodiment of a system configured to detect the position of one or more vehicles 1a, such as an assisted-driving or autonomous-driving PMV, or an AMR vehicle, in a given environment, such as an airport, a railway station, a hospital, or a shopping mall. For a general description of such a vehicle 1a, reference may be made to the description of FIGS. 1 and 2.

In particular, the inventors have noted that in many environments surveillance cameras 2 are provided. Consequently, a computer 3a, such as a remote server and/or a cloud platform, for example via an appropriate programming software, can receive from each camera 2 installed in the environment (or at least a sub-set of such cameras 2) a respective image 306 (or a sequence of images) and verify whether this image 306 comprises at least one of the vehicles 1a. Consequently, knowing the position of each camera 2, the processor 3a is able to identify the position POS of the vehicle or vehicles 1a that is/are captured in the respective image 306.

However, frequently these images 306 supplied by surveillance cameras 2 can be used only for reasons of security, and not for further processing operations, for example, in order to guarantee privacy of other people that may appear in the images.

FIG. 4 shows a second embodiment of a system configured to detect the absolute position of a PMV 1a.

In particular, as compared to FIG. 3, the system comprises a first processor 20 configured to acquire the images 306 from the cameras 2. Typically, this processor 20 is installed in the environment in which the cameras 2 are installed. For instance, the processor 20 may correspond to (or at least implement) a DVR (Digital Video Recorder) and/or an NVR (Network Video Recorder) configured to acquire the video streams of the cameras 2 in such a way as to show the respective images 306 to an operator, for example, via a screen or a further processor 24 and/or to store the video streams in a memory 22, such as a nonvolatile memory, for example, comprising one or more HDDs (Hard Disk Drives) and/or SSDs (Solid-State Drives).

In the embodiment considered, the processor 20 is configured to send one or more images 312 of each camera 2 also to the processor 3a. However, in various embodiments, the processor 20 is configured not to transmit the original images 306 acquired, but pre-processes the images 306 in such a way as to obfuscate the images, in particular in such a way as to render the faces of persons that appear in the images unrecognizable. Preferably, communication between the processors 20 and 3a is implemented by means of an encrypted protocol, for example, using one of the versions of the TLS (Transport Layer Security) protocol, for example, applied to the TCP (Transmission Control Protocol) or UDP (User Datagram Protocol).

Consequently, in the embodiment considered, the processor 3a is configured to receive from the processor 20 obfuscated images 312 and detect one or more vehicles 1a in the obfuscated images 312. Consequently, in the embodiment considered, the processor 3a should be able to identify a vehicle 1a also in the obfuscated images 312. In particular, for this purpose, each vehicle 1a is provided with given patterns P that enable location of the vehicle itself, in particular in order to determine the odometry centre of the vehicle 1a. Consequently, in various embodiments, the vehicle 1a is configured, for example via appropriate programming of the processing system 60, to receive a position POS from the processor 3a, reset the position of the odometry centre of the vehicle 1a to the above received position POS, and then compute the position of the vehicle 1a, once again via odometry, to determine the displacements of the vehicle 1a.

Consequently, in various embodiments, the patterns and the obfuscating algorithm are configured in such a way as to enable an identification of the patterns P also in the obfuscated image 312. In general, all the vehicles may have the same pattern P, or preferably each vehicle 1a has applied to it a different pattern P. For instance, in various embodiments, the patterns P applied to different vehicles may have different shapes and/or colours. For instance, in various embodiments, one or more of the patterns P applied to a vehicle 1a comprise a two-dimensional bar code, such as a QR code, where this two-dimensional bar code identifies a univocal code of the respective vehicle 1a. Preferably, the patterns P are configured to enable determination not only of the position POS of the respective vehicle 1a, but also of the orientation of the vehicle 1a.

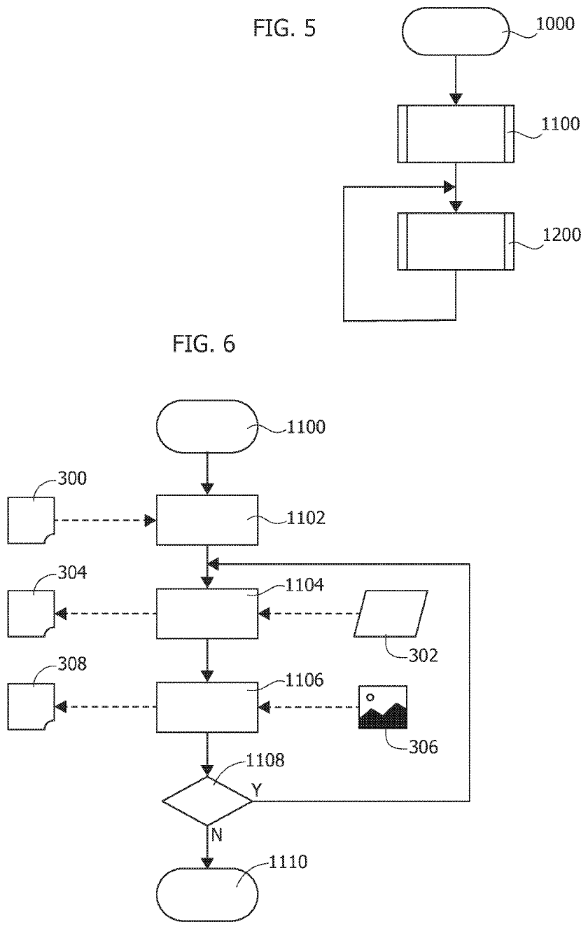

FIG. 5 shows an embodiment of operation of the processor 3a. In the embodiment considered, after a starting step 1000, the processor 3a proceeds to a learning phase 1100, in which it learns the correspondences between the images supplied by the processor 20, i.e., the cameras 2, and the maps of the environment, for example, the map of the structure, such as an airport, a railway station, a hospital, or a shopping mall. Next, the processor 3a proceeds to a localization phase 1200, in which it uses the obfuscated images 312 supplied by the processor 20 for locating one or more vehicles 1a in the map of the environment.

FIG. 6 shows an embodiment of the learning step 1100.

In particular, once the learning phase 1100 has been started, the processor 1102 receives, in a step 1102, data 300 that identify a map of the environment in which the vehicles 1a are moving, for example, a map that comprises the corridors and rooms of the structure, in particular at least the area to which the vehicles 1a can gain access. Preferably, this map 300 is a two-dimensional (2D) map. In general, the data 300 may also comprise data that identify points of interest, for example, the terminals of an airport, the wards of a hospital, the shops of a shopping mall, etc. Consequently, these data 300 may also correspond to or comprise the data used for planning the global routes used for navigation of the vehicles 1a (see also the description of FIG. 2).

In a step 1104, the processor then receives data 302 that identify the position of a given camera 2 in the map 300. For instance, the position data of the map 300 and/or of the camera 2 may be expressed in terms of latitude and longitude (absolute position) or in cartesian co-ordinates x and y (relative position with respect to a reference of the map). Consequently, in step 1104, the processor can add the position of the camera 2 (possibly converted into the co-ordinates of the map) to a list 304, which hence comprises the positions of the cameras 2. In general, the data 302 can be received directly as position data, or the processor 3a could also display a screenful that shows the map 300, and an operator could position the camera 2 directly in the map using a graphic interface. Moreover, the data 302 and likewise the list 304 may also comprise the orientation of the camera 2. Finally, the list 304 further comprises data that enable identification of the respective camera 2, for example, a univocal camera code, and possibly respective access data for acquiring an image of the respective camera 2 through the processor 20.

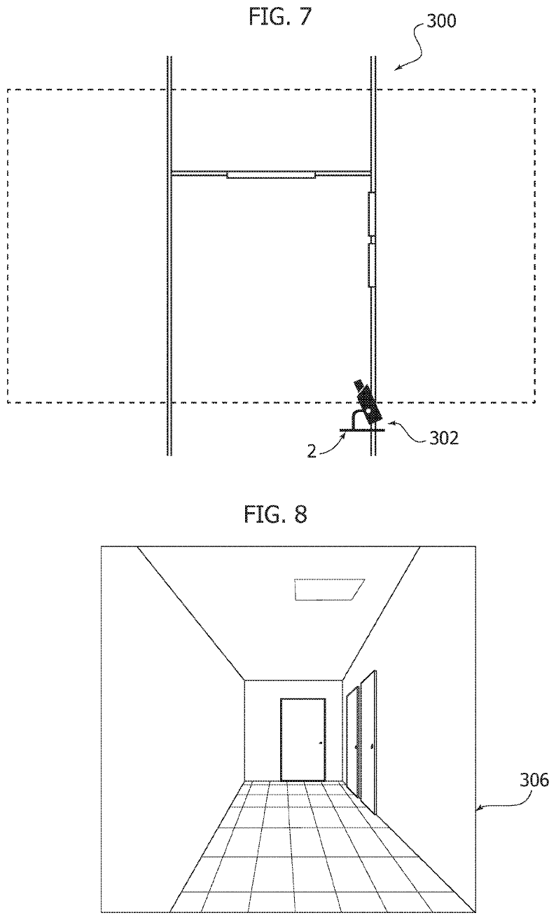

Consequently, at the end of step 1104, the processor knows the position of the camera 2 in the map 300. For instance, FIG. 7 shows an example of an extract of the map 300, and the respective position 302 of a camera 2. For instance, FIG. 7 shows a 2D view of a corridor.

In a step 1106, the processor 3a then receives an image 306 of the respective camera 2. In particular, this image 306 is not obfuscated. An example of an image 306 for the scenario of FIG. 7 is illustrated in FIG. 8. In various embodiments, since this image 306 is not obfuscated, it is not supplied directly by the processor 20, but an operator manually selects one of the images 306 acquired by the camera 2, such as preferably an image that does not comprise people, thus guaranteeing privacy. Consequently, in various embodiments, the processing system 3a can request, in step 1106, uploading of an image file, which corresponds to an image acquired with the camera 2a.

Moreover, the processing system 3a is configured to generate, in step 1106, mapping data 308, for example in the form of a look-up table, which make it possible to associate the co-ordinates in the image 306, in particular co-ordinates in the plane of the floor/ground, to co-ordinates in the map 300.

For instance, in various embodiments, this operation is performed manually by an operator, who selects a first position in the image 306 and a corresponding position in the map 300 (or vice versa). Alternatively, the processor can determine automatically the correspondences, for example by identifying characteristic points, such as corners, etc.

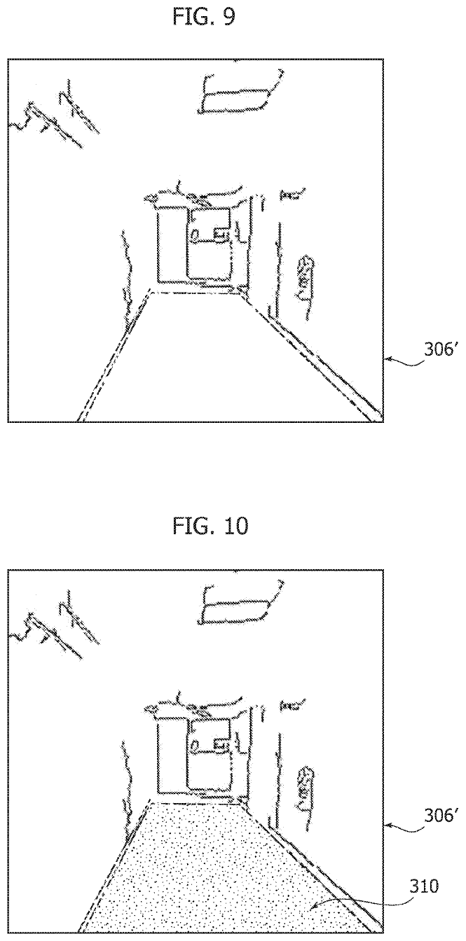

In either case, the processor 3a can then identify the floor/ground in the image 306. For this purpose, the processor 3a can pre-process the image 306, for example by means of an edge-detection/edge-extraction algorithm. For instance, FIG. 9 shows an example of a pre-processed image 306′ obtained via an edge-detection operation applied to the image 306 of FIG. 8.

Next, the processor can calculate a vanishing point of the pre-processed image and use this information to find correspondences between the map 300 and the image 306′, in particular to identify the floor/ground 310. The person skilled in the art will appreciate that solutions of this type are known in the field of navigation of autonomous-driving vehicles, where a similar camera is mounted on the vehicle itself, which here renders any detailed description superfluous. For instance, for this purpose, there may be cited the document by Chai, Wennan & Chen, C & Edwan, Ectzaldeen, “Enhanced Indoor Navigation Using Fusion of IMU and RGB-D Camera”, 2015, 10.2991/cisia-15.2015.149, or the document by François Pasteau, Vishnu Karakkat Narayanan, Marie Babel, François Chaumette, “A visual servoing approach for autonomous corridor following and doorway passing in a wheelchair” Robotics and Autonomous Systems, Elsevier, 2016, 75, part A, pp. 28-40, ff10.1016/j.robot.2014.10.017ff.ffhal01068163v2, the contents of which are incorporated herein for reference.

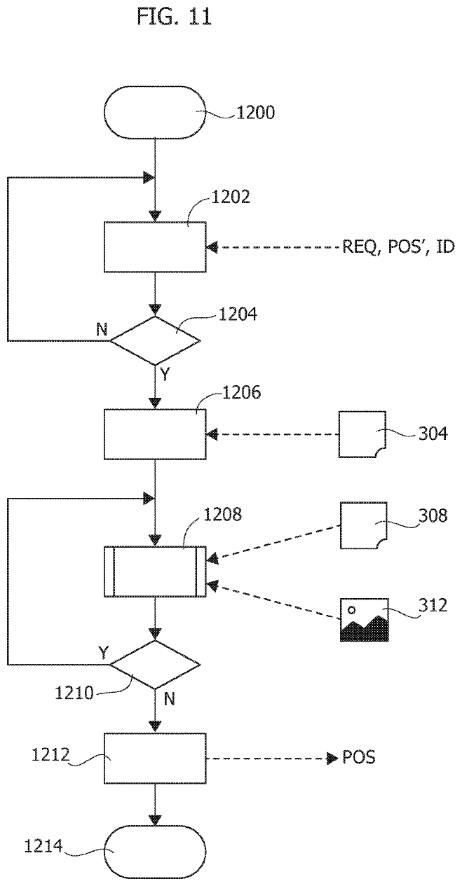

Consequently, once the processor 3a has identified the floor/ground 310 in the image 306′ (see, for example, FIG. 10), the operator can manually select a plurality of points of the floor 310 in the image 306′ and corresponding points in the map 300 (see FIG. 7). Alternatively or additionally, the processor 3a can find one or more correspondences automatically. However, also in the case where the processor 3a detects correspondences automatically, preferably an operator checks these correspondences and possibly changes the data and/or adds further correspondences. Hence, knowing the correspondence of a plurality of points in the image 306 and in the map 300, the processor 3a is able to calculate, via conventional camera models, for each co-ordinate (pixel) of the floor/ground 310 in the image 306, a respective area in the map 300.

Additionally or alternatively, the processor 3a can determine, in step 1106, the parameters of a model of the camera 2, which enables calculation of the distance of a point in the image 306 from the camera 2, which can then be used for finding automatically the correspondences and/or for determining directly the position of a given pixel of the floor/ground 310 in the map 300. For instance, for this purpose, there may be cited the document U.S. Pat. No. 10,380,433 B2, the contents of which are incorporated herein for reference. In particular, this document describes, with reference to the respective FIGS. 11a, 11b, and 11c, solutions for determining the parameters of a model of a camera that are able to calculate the distance of an object from the camera. In particular, this model requires the knowledge of the height of installation of the camera 2. Hence, the data 302 may comprise also this information.

Consequently, at the end of step 1106, the processor 3a has saved a list and/or the parameters of a model of the camera 308, which enables association of each pixel of the floor/ground 310 of the image 306 to respective co-ordinates in the map 300.

The processor 3a then proceeds to a verification step 1108, in which it checks whether all the cameras 2 have been uploaded. For instance, in the case where the position data 302 already comprise the data of a plurality of cameras 2, the processor can use this list to determine automatically whether a further camera 2 is to be processed. Otherwise, the processor 3a can display, in step 1108, a screenful that makes it possible to complete the procedure or enter a further camera 2. Consequently, in the case where a further camera 2 is to be added (output “Y” from the verification step 1108), the processor returns to step 1104. Instead, in the case where all the cameras 2 have been added (output “N” from the verification step 1108), the processor proceeds to an end step 1110, and the learning step 1100 terminates.

FIG. 11 shows an embodiment of the localization phase 1200.

In particular, in the embodiment considered, the processor 3a is configured to receive, in a step 1202, a request of location REQ by a vehicle 1a. For instance, in a way similar to what has been described with reference to FIG. 2, the processor 3a and the vehicle 1a can communicate through the communication interface 64. In various embodiments, the request REQ comprises data that identify the respective vehicle 1a, such as a univocal vehicle code ID. In particular, in the embodiment considered, the processor 3a waits, in step 1202, until a request REQ is received, as illustrated schematically via a verification step 1204. In particular, in the case where no request REQ has been received (output “N” from step 1204), the processor 3a returns to step 1202. Instead, in the case where a request REQ has been received (output “Y” from step 1204), the processor 3a proceeds to a step 1206.

In particular, in step 1206, the processor 3a reads the list of cameras 304 and selects a first camera 2. Next, the processor 3a obtains an obfuscated image 312 from the processor 20 for the respective camera 2, for example using, for this purpose, the identifier of the camera 2 and possibly the respective access data. Consequently, by identifying the position of one or more vehicles 1a in the obfuscated image 312, in particular a respective position on the floor/ground 310, the processor 3a can use the data 308 for determining the respective position POS of a vehicle 1a in the map 300. In various embodiments, and as will be described in greater detail hereinafter, the processor determines, in step 1208, also the identifier of the vehicle 1a that is included in the image. For instance, as mentioned previously, for this purpose there may be applied different combinations of patterns P to the vehicles 1a, and the processor can store also data that associate to each combination of patterns P a respective univocal vehicle code ID, i.e., a respective vehicle 1a.

In the embodiment considered, the processor 3a then checks, in a step 1210, whether further cameras 2 are to be processed. In the case where further cameras 2 are to be processed (output “Y” from the verification step 1210), the processor selects a next camera 2 and returns to step 1210. Instead, in the case where all the cameras 2 have been processed (output “N” from the verification step 1210), the processor 3a proceeds to a step 1212, in which it sends the position POS to the vehicle 1a. In particular, in various embodiments, the processor selects, in step 1212, the position POS of the vehicle 1a that corresponds to the vehicle 1a that has sent the request REQ. For instance, for this purpose, the processor can determine the univocal vehicle code ID associated to the combination of patterns P detected and compares this univocal vehicle code ID with the univocal vehicle code ID received with the request REQ. Finally, the location method terminates in an end step 1214.

In general, the processor 3a can request, via steps 1208 and 1210, the obfuscated images 312 for all the cameras 2. Alternatively, the processor 3a can receive, in step 1202, together with the request REQ, also a position POS′ that the vehicle 1a has estimated, for example, through odometry. Consequently, knowing the estimated position POS′ of the vehicle 1a, the processor 3a can determine, in step 1206 (using the data 304), only the list of the cameras 2 that acquire images that will cover the respective position POS′, using for this purpose the list 304 and/or the data 308. Consequently, in this way, step 1208 is repeated only for the camera or cameras 2 that can potentially record the vehicle 1a that has sent the request REQ.

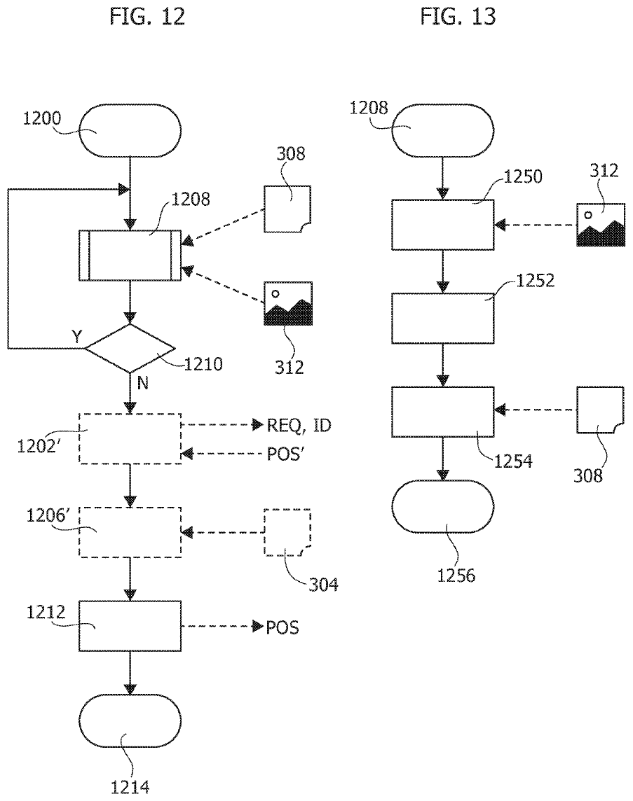

Consequently, in FIG. 11, the processor determines the position POS of a vehicle 1a that has sent a request REQ. Instead, FIG. 12 shows a second embodiment of the localization phase 1200.

In particular, in the embodiment considered, using the verification step 1210, the processor 3a repeats step 1208 for all the cameras 2 included in the list 304. Consequently, in the embodiment considered, the processor 3a determines, via steps 1208 and 1210, the positions POS of all the vehicles 1a that appear in the obfuscated images 312.

In the embodiment considered, the processor 3a then sends, in step 1212, to each vehicle 1a that has been identified, the respective position POS, and the procedure terminates in step 1214. For instance, for this purpose, the processor can determine the univocal vehicle code ID associated to each combination of patterns P detected and send the respective position POS to the vehicle 1a identified via said univocal vehicle code ID.

Optionally, the processor 3a can also in this case verify whether the position POS is plausible. For instance, for this purpose, the processor can send, in a step 1202′, a request REQ to each vehicle 1a (identified via the respective code ID) to request the estimated position POS′ of the vehicle. Next, the processor 3a can compare, in a step 1206′, the estimated position POS′ with the position POS, for example checking whether the position POS′ can be recorded by the respective camera 2 as indicated, for example, via the list 304 and/or the data 308.

Consequently, in the embodiments considered, the processor 3a is configured for analysing, in step 1208, an obfuscated image 312 supplied by the processor 20 to identify the position POS of one or more vehicles 1a that appear in the image 312.

FIG. 13 shows a possible embodiment of step 1208.

In particular, once the procedure 1208 has been started for a given camera 2, the processor 3a receives from the processor 20, in a step 1250, the obfuscated image 312 for the aforesaid camera 2.

In the embodiment considered, the processor 3a then determines, in a step 1252, whether the image 312 comprises one or more vehicles 1a and determines, for each vehicle 1a, the position of the odometry centre of the vehicle 1a in the image 312. In particular, the odometry centre refers to the co-ordinates around which the vehicle 1a turns and moves. The odometry centre is hence used by the vehicle 1a, in particular by the processing circuit 60, to estimate the position POS′ as a function of the displacement data S2. Typically, it is located at the centre of the drive wheels, at the height of the ground for a vehicle that moves in 2D.

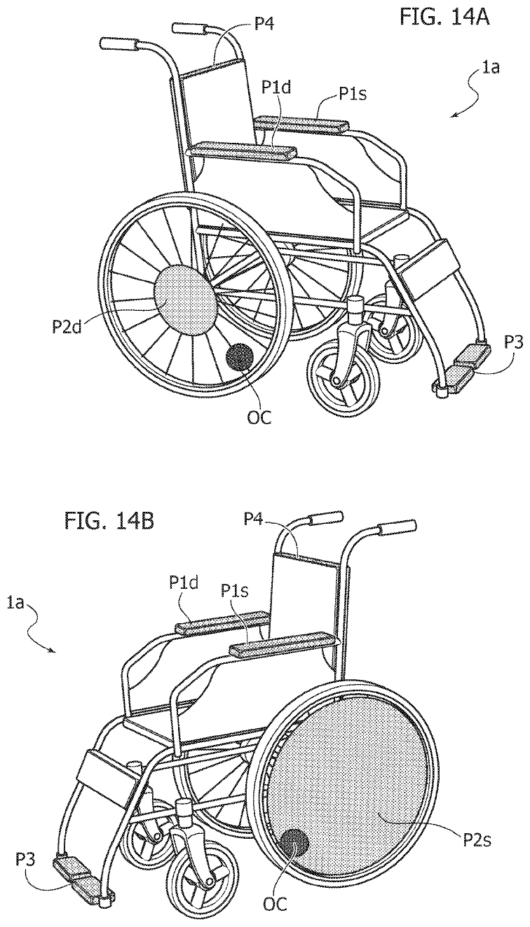

For instance, this is illustrated schematically in FIG. 14A and 14B, which show two views of the vehicle 1a itself and the corresponding odometry centre OC.

As explained previously, the images 312 supplied by the processor 20 are obfuscated. Consequently, to enable a location of the vehicle 1a also in the obfuscated image 312, in various embodiments, each vehicle 1a comprises purposely provided visual patterns P (e.g., LEDs or specific images) that can be easily identified and help in obtaining an understanding of the shape, the orientation of the vehicle, and consequently the odometry centre OC. For instance, as illustrated in FIGS. 14A and 14B, the vehicle 1a may comprise one or more of the following patterns P:
two strips P1s and P1d, applied, respectively, to the armrests (the left one and the right one) of the vehicle 1a;
two circular patterns P2s and P2d, possibly with different diameters, applied, respectively, to the rear wheels (the left one and the right one) of the vehicle 1a;
an optional pattern P3 applied to a footrest of the vehicle 1a; and
an optional pattern P4 applied to the rear side of the backrest of the vehicle 1a.

In this context, it is useful to apply a number of visible patterns P for each side, because some patterns P might be covered. Preferably, these patterns P present a high contrast, in such a way that the processor 20 can easily filter the image 306 received from the camera 2 so as to leave only the patterns P in the obfuscated image 312. For instance, for this purpose, the patterns P may have one or more specific colours, which enables the processor 20 to filter the image, keeping only the pixels that have the aforesaid colour or colours. Consequently, the combinations of the patterns P applied to the various vehicles 1a can be distinguished by a different combination of colours of the patterns P applied to the vehicles 1a, and/or by varying the shape of the patterns P, for example, by applying a two-dimensional bar code to each vehicle 1a. For instance, this bar code, such as a QR code, could be provided on the patterns P2s, P2d, and P4.

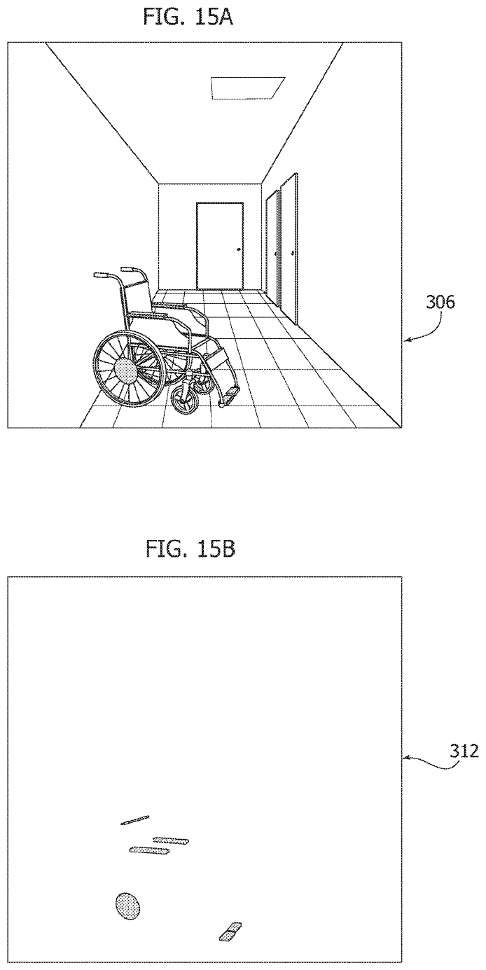

For instance, FIG. 15A shows an image 306′ as supplied by the camera 2, and FIG. 15B shows a corresponding obfuscated/filtered image 312 generated by the processor 20. For instance, in the embodiment considered, the processor 20 is configured to generate the obfuscated image 312 by filtering the original image 306 with one or more filters that maintain only some specific colours.

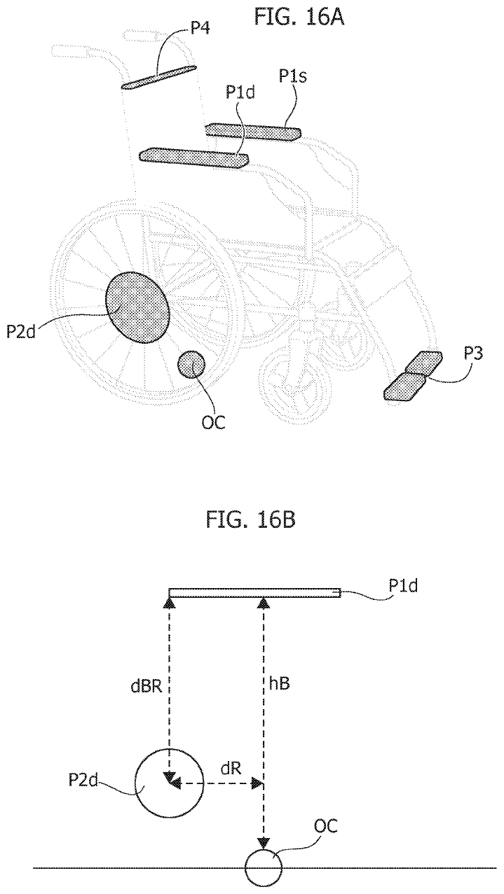

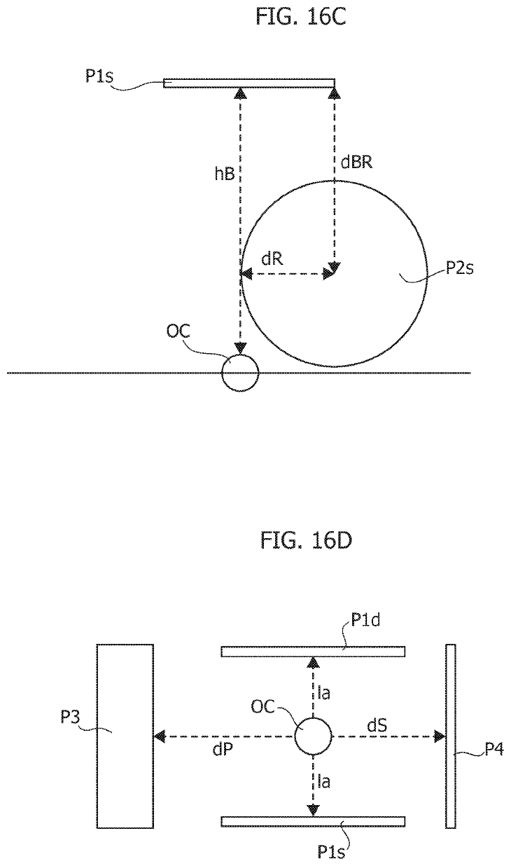

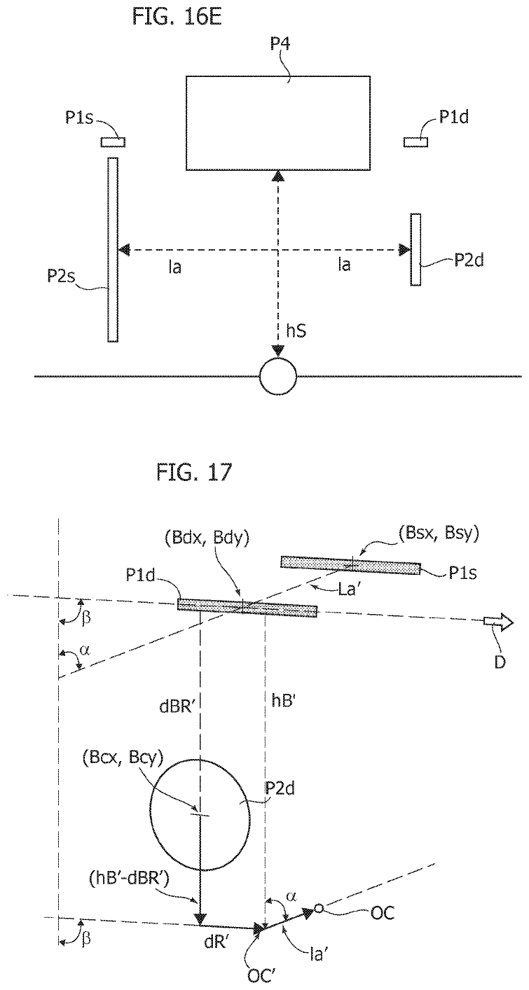

Consequently, once the patterns P are known, it is possible to define the position of the odometry centre OC and optionally the direction D of the vehicle 1a on the basis of the patterns P. For instance, this is illustrated in FIGS. 16A to 16E.

In particular, FIGS. 16A illustrate again the embodiment of the vehicle 1a of FIG. 14A, in which the patterns P are highlighted.

As illustrated in FIG. 16B, which shows a side view of the vehicle 1a, the centre of the pattern P2d applied to the right wheel is at a given distance dBR from the pattern P1d applied to the right armrest. In this case, the centre OC is located:
with respect to the axis x, at a distance dR from the centre of the right wheel, i.e., from the centre of the pattern P2d; and
with respect to the axis z, at a distance hB from the right armrest, i.e., from the pattern P1d.

Consequently, by detecting the distance dBR between the pattern P1d and the centre of the pattern P2d, the processor 3a can calculate proportionally the distances hB and dR. As illustrated in FIG. 16C, similar considerations apply also to the relation between the patterns P1s and P2s; namely, by detecting the distance dBR between the pattern P1s and the centre of the pattern P2s, the processor 3a can calculate proportionally the distances hB and dR.

Instead, FIG. 16D shows a top plan view of the vehicle 1a. In this case, the centre OC is located:
with respect to the axis y, half-way between the armrests, i.e., at half the distance La between the patterns P1s and P1d, i.e., at a distance la=La/2 with respect to the pattern P1d or the pattern P1s; and
with respect to the axis x, at a distance dS from the pattern P4 and a distance dP from the pattern P3.

Consequently, by detecting the distance La between the pattern P1d and the pattern P1s, the processor 3a can calculate proportionally the distances la, and dS and/or dP.

Finally, FIG. 16E shows a view from the back of the vehicle 1a. In this case, the centre OC is located:
with respect to the axis y, half-way along the vehicle 1a, for example, half-way between the patterns P2d and P2s, half-way along of the pattern P4, or at half the distance La between the patterns P1s and P2s; and
with respect to the axis z, at a distance hB from the pattern P1d or the pattern P1s, or at a distance hS from the pattern P4.

Consequently, by detecting, for example, the distance La between the pattern P1d and the pattern P1s, the processor 3a can calculate proportionally the distances la and hS (or hB).

Consequently, in various embodiments, as also illustrated in FIG. 17, the processor 3a can carry out, in step 1252, the following operations, which are performed directly with the co-ordinates x (horizontal co-ordinate) and y (vertical co-ordinate) of the pixels of the image 312:
determining the centre (Bcx, Bcy) of the pattern P2d (or likewise of the pattern P2s);
measuring, in the direction y, the distance dBR′ between the centre (Bcx, Bcy) of the pattern P2d (or likewise of the pattern P2s) and of the pattern P1d (or likewise P1s);
knowing the distances hB and dBR, calculating the distances hB′=(hB/dBR)·dBR′ and dR′=(dR/dBR)·dBR′;
calculating the position of the floor/ground with respect to the centre (Bcx, Bcy) by adding the distance (hB′−dBR′) in the direction y, i.e., (Bcx, Bcy+(hB′−dBR′));
determining data that indicate the orientation β of the pattern P1d (or likewise of the pattern P1s) with respect to the axis y, for example, in the form of a vector in the longitudinal direction of the pattern P1d;
calculating the position OC′ of the odometry centre in the plane of the pattern P2d and P1d (or likewise P2s and P1s) by adding to the previous position of the floor/ground a vector of length dR′ and orientation β;
determining the centre (Bdx, Bdy) of the pattern P1d and the centre (Bsx, Bsy) of the pattern P1s;
determining a vector La′ between the points (Bdx, Bdy) and (Bsx, Bsy), i.e., (Bsx−Bdx, Bsy−Bdy), where this vector has an orientation a with respect to the axis y; and
calculating the position of the odometry centre OC by adding a vector la′=La′/2 to the point OC′.

In this context, the inventors have noted that the position OC′ can frequently be estimated also in an approximate way via the following steps:
determining the centre (Bdx, Bdy) of the pattern P1d; and
estimating the position OC′ of the odometry centre in the plane of the patterns P2d and P1d (or likewise P2s and P1s) by adding to the point (Bdx, Bdy) the distance (hB′) in the direction y, i.e., OC′=(Bdx+hB′, Bdy).

To the above estimated position there can then be added again the vector la′.

Consequently, in the embodiment, when a vehicle 1a is detected in the image 312, the processor 3a can determine the position (Ox, Oy) of the odometry centre OC in the image 312 and preferably also the direction β of the vehicle 1a as a function of the patterns P that are detected, and in particular as a function of the distance between them.

Consequently, once the processor has determined, in step 1252, the co-ordinates of the odometry centre OC as a function of the distances between the patterns (and possibly of their dimensions), the processor 3a uses, in a step 1254, the data 308 to calculate the position POS of the vehicle 1a by mapping the co-ordinates (Ox, Oy) of the image in the map 300. Finally, step 1208 terminates at an end step 1256.

As explained previously, in various embodiments, the processor 3a determines, in step 1208, the identification of the vehicle 1a that is comprised in the image 312. For instance, as mentioned previously, for this purpose, different combinations of patterns P may be applied to the vehicles 1a, and the processor 3a may also store data that associate to each combination of patterns P a respective univocal vehicle code ID, i.e., a respective vehicle 1a. Consequently, to associate a given combination of patterns P to a respective univocal vehicle code ID, the patterns may be static and univocal. For instance, as mentioned previously, the patterns P applied to different vehicles may have different shapes and/or colours. For instance, in various embodiments, one or more of the patterns P applied to a vehicle 1a comprise a two-dimensional bar code, such as a QR code, where this two-dimensional bar code identifies a univocal code of the respective vehicle 1a.

However, in the case where a large number of vehicles 1a are circulating, identification via static patterns could become inefficient. Consequently, in various embodiments, the vehicles 1a (or at least some of the vehicles 1a) comprise one or more dynamic patterns. For instance, the vehicle 1a may comprise at least one dynamic pattern P5 on the left-hand side of the vehicle 1a and one dynamic pattern P5 on the right-hand side of the vehicle 1a. For instance, the pattern P5 could be used instead of, or be integrated in, the pattern P1s and/or the pattern P1d.

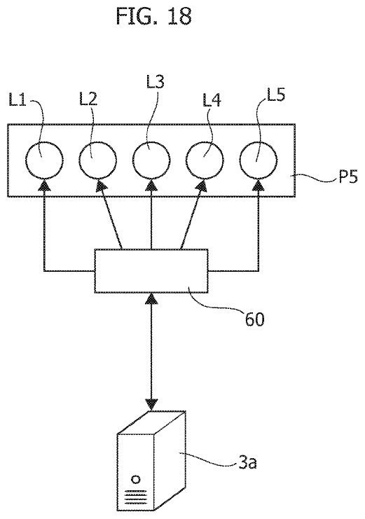

For instance, FIG. 18 shows an embodiment of a dynamic pattern P5. In particular, in the embodiment considered, the dynamic pattern P5 comprises a plurality of visual/light indicators L, such as LEDs, which can be selectively activated or de-activated. For instance, FIG. 18 illustrates five indicators L1, L2, L3, L4, and L5.

In particular, in various embodiments, a dynamic pattern P5 comprises a control circuit, for example implemented by the processor 60, configured to activate or de-activate each indicator L as a function of data received from the processor 3a, for example using, for this purpose, the communication interface 64. In general, the number of the indicators L could hence be chosen to enable a univocal identification of each vehicle 1a. However, in various embodiments, the number of the indicators L is low and chosen, for example, between 3 and 10, preferably between 4 and 6. Consequently, in this case, it is not possible to identify all the vehicles 1a univocally.

However, as explained previously, the processor 3a can also receive, in step 1202/1202′, the estimated position POS′ of each vehicle 1a. Consequently, the processor 3a is able to determine which vehicles 1a may be included in a given image 312. Consequently, in the case where the image 312 only shows a single vehicle 1a and no other vehicles 1a are nearby (as indicated by the estimated position POS′), the processor 3a can determine, in step 1208, in a univocal way the vehicle code ID using the estimated position POS′ of the vehicles. For instance, the processor 3a can classify two vehicles 1a as being close to one another if the distance between them is less than a given threshold, for example, when the distance is less than 10 m.

Instead, in the case where there exist ambiguities, for example, because two vehicles 1a are included in one and the same image 312 and/or two vehicles 1a are in estimated positions POS′ that are close to one another, the processor 3a can configure the dynamic patterns P5 of the vehicles 1a that are close (as indicated by the estimated positions POS′), for example sending commands to the processor 60 in such a way that these vehicles 1a use different dynamic patterns P5, which at this point are not necessarily univocal for all the vehicles 1a. For instance, in the embodiment considered, a first vehicle could use the pattern “11001” for the indicators L, and a second vehicle could use the pattern “10101” for the indicators L.

Consequently, in various embodiments, the processor can receive, in step 1202, the positions POS′ of all the vehicles 1a, determine for each vehicle 1a a sub-set of vehicles 1a that are near the vehicle 1a, and configure the dynamic patterns P5 of the vehicles 1a of the sub-set in such a way that each vehicle 1a of the sub-set uses a different activation/de-activation pattern (univocal for the sub-set) for the indicators L. Consequently, in this way, the subsequent step 1208 can identify, once again univocally, each vehicle 1a detected, using for this purpose the estimated positions POS′ and the profiles of the dynamic patterns P5. Likewise, step 1202′ could be modified. In this case, step 1202′ should be carried out prior to step 1208, or step 1208 should be repeated.

In general, instead of using a dynamic pattern P5 that identifies a different code via a spatial distribution of the indicators L, the dynamic pattern P5 may also comprise a single indicator L, or in general one or more indicators L, configured to be activated and de-activated in time, thus identifying the respective vehicle 1a with a modulation in time. For instance, to implement the identification pattern “11001”, the processor 60 could switch on an indicator L for two time periods, then switch off the indicator L for two time periods, and then switch on the indicator L for one time period. The person skilled in the art will appreciate that the duration of the time period should be chosen on the basis of the maximum image-acquisition time 312. In this case, the processor 3a could then repeat step 1208 a plurality of times to identify for each image 312 the respective on/off state of the indicator, which thus makes it possible to identify, once again univocally, the respective pattern and hence the respective vehicle 1a.

Of course, without prejudice to the principle of the invention, the details of construction and the embodiments may vary widely with respect to what has been described and illustrated herein purely by way of example, without thereby departing from the scope of the present invention, as defined by the ensuing claims.

1. A method of locating a vehicle in an environment via a plurality of surveillance cameras installed in said environment, wherein said vehicle comprises a plurality of sensors configured to acquire data identifying a displacement of said vehicle, and wherein said vehicle is configured to estimate a position of an odometry centre of said vehicle via odometry as a function of said data identifying a displacement of said vehicle, wherein a plurality of visual patterns are applied to said vehicle, and wherein the method comprises the steps of:
during a learning phase:
receiving a map of said environment;
receiving for each camera an image acquired by the respective camera, and generating data permitting to associate a pixel of a ground in said image to respective coordinates in said map;
during a localization phase, repeating the following steps for at least one of said surveillance cameras:
receiving an obfuscated image from the camera, and verifying whether said obfuscated image shows one or more of said visual patterns applied to said vehicle; and
in case said obfuscated image shows one or more of said visual patterns applied to said vehicle:
calculating the position of an odometry centre in said obfuscated image as a function of the positions and optionally the dimensions of said visual patterns shown in said obfuscated image,
determining a position of said odometry centre in said map -by mapping said position of said odometry centre (OC) in said obfuscated image in coordinates in said map by using said data permitting to associate a pixel of a ground in said image to respective coordinates in said map, and
sending said position of said odometry centre in said map to said vehicle, wherein said vehicle is configured to set the estimated position of said odometry centre to said position received.

2. The method according to claim 1, wherein a plurality of said vehicles move in said environment, wherein each vehicle of said plurality of vehicles comprises a combination of univocal patterns, wherein the method comprises the steps of:
storing data associating each combination of univocal patterns with a respective vehicle identified via a respective univocal vehicle code; and
in case said obfuscated image shows one or more of said visual patterns, determining the univocal vehicle code associated with the respective pattern combination, and sending said position of said odometry centre in said map to the vehicle identified via said univocal vehicle code.

3. The method according to claim 2, wherein each combination of univocal patterns comprises patterns with different shapes and/or colors.

4. The method according to claim 3, wherein said patterns include a bi-dimensional barcode, such as a QR code, wherein said bi-dimensional barcode identifies the respective univocal vehicle code.

5. The method according to claim 1, wherein a plurality of said vehicles move in said environment, wherein each vehicle of said plurality of vehicles comprises a dynamic pattern comprising a plurality of indicators, wherein the method comprises the steps of:
receiving the estimated positions of said vehicles of said plurality of vehicles, and determining a sub-set of vehicles of said plurality of vehicles which are nearby;
configuring the dynamic pattern of each vehicle of said sub-set of vehicles, in order to switch-on different combination of said indicators for each vehicle of said sub-set of vehicles,
storing data associating the estimated position and the combination of said indicators of each vehicle of said sub-set of vehicles with a respective vehicle identified via a univocal vehicle code; and
in case said obfuscated image shows one or more of said visual patterns, comparing for each vehicle of said sub-set of vehicles the respective estimated position with said determined position and the combination of patterns detected with said combination of said indicators in order to select a vehicle of said sub-set of vehicles, and sending said position of said odometry centre in said map to the selected vehicle.

6. The method according to claim 1, wherein said generating data permitting to associate a pixel of a ground in said image to respective coordinates in said map comprises:
pre-process said image by means of an edge detection/extraction algorithm; and
identify a floor in said image by using said pre-processed image.

7. The method according to claim 1, wherein said patterns have one or more predetermined colors and wherein said obfuscated image is obtained by means of a filtering operation that maintains only said one or more predetermined colors.

8. The method according to claim 1, wherein the method comprises the stages of:
receiving for each camera respective coordinates in said map;
during said localization phase, receiving the estimated position of said vehicle, select a subset of cameras according to said estimated position of said vehicle and the coordinates of said cameras, and receiving the obfuscated images of the cameras of said sub-set of cameras.

9. The method according to claim 1, wherein said vehicle is a personal mobility vehicle, an automated guided vehicle or an autonomous mobile robot.

10. A system for locating a vehicle in an environment via a plurality of surveillance cameras installed in said environment, including:
one or more vehicles, wherein each vehicle comprises a number of sensors configured to acquire data identifying a displacement of said vehicle, and wherein said vehicle is configured to estimate a position of an odometry centre of said vehicle by odometry according to said data identifying a displacement of said vehicle, where a plurality of visual patterns are applied to said vehicle, and
a processing system configured to perform operations comprising:
during a learning phase:
receiving a map of said environment;
receiving for each camera an image acquired by the respective camera, and generating data permitting to associate a pixel of a ground in said image to respective coordinates in said map;
during a localization phase, repeating the following steps for at least one of said surveillance cameras:
receiving an obfuscated image from the camera, and verifying whether said obfuscated image shows one or more of said visual patterns applied to said vehicle; and
in case said obfuscated image shows one or more of said visual patterns applied to said vehicle:
calculating the position of an odometry centre in said obfuscated image as a function of the positions and optionally the dimensions of said visual patterns shown in said obfuscated image,
determining a position of said odometry centre in said map by mapping said position of said odometry centre in said obfuscated image in coordinates in said map by using said data permitting to associate a pixel of a ground in said image to respective coordinates in said map, and
sending said position of said odometry centre in said map to said vehicle, wherein said vehicle is configured to set the estimated position of said odometry centre to said position received.

11. The system of claim 10, wherein a plurality of said vehicles move in said environment, wherein each vehicle of said plurality of vehicles comprises a combination of univocal patterns, wherein the operations further comprise:
storing data associating each combination of univocal patterns with a respective vehicle identified via a respective univocal vehicle code; and
in case said obfuscated image shows one or more of said visual patterns, determining the univocal vehicle code associated with the respective pattern combination, and sending said position of said odometry centre in said map to the vehicle identified via said univocal vehicle code.

12. The system of claim 11, wherein each combination of univocal patterns comprises patterns with different shapes and/or colors.

13. The system of claim 12, wherein said patterns include a bi-dimensional barcode, such as a QR code, wherein said bi-dimensional barcode identifies the respective univocal vehicle code.

14. The system of claim 10, wherein a plurality of said vehicles move in said environment, wherein each vehicle of said plurality of vehicles comprises a dynamic pattern comprising a plurality of indicators, wherein the operations comprise:
receiving the estimated positions of said vehicles of said plurality of vehicles, and determining a sub-set of vehicles of said plurality of vehicles which are nearby;
configuring the dynamic pattern of each vehicle of said sub-set of vehicles, in order to switch-on different combination of said indicators for each vehicle of said sub-set of vehicles,
storing data associating the estimated position and the combination of said indicators of each vehicle of said sub-set of vehicles with a respective vehicle identified via a univocal vehicle code; and
in case said obfuscated image shows one or more of said visual patterns, comparing for each vehicle of said sub-set of vehicles the respective estimated position with said determined position and the combination of patterns detected with said combination of said indicators in order to select a vehicle of said sub-set of vehicles, and sending said position of said odometry centre in said map to the selected vehicle.

15. The system of claim 10, wherein said generating data permitting to associate a pixel of a ground in said image to respective coordinates in said map comprises:
pre-process said image by means of an edge detection/extraction algorithm; and
identify a floor in said image by using said pre-processed image.

16. The system of claim 10, wherein said patterns have one or more predetermined colors and wherein said obfuscated image is obtained by means of a filtering operation that maintains only said one or more predetermined colors.

17. The system of claim 10, wherein the operations further comprise:
receiving for each camera respective coordinates in said map; and
during said localization phase, receiving the estimated position of said vehicle, select a subset of cameras according to said estimated position of said vehicle and the coordinates of said cameras, and receiving the obfuscated images of the cameras of said sub-set of cameras.

18. The system of claim 10, wherein said vehicle is a personal mobility vehicle, an automated guided vehicle, or an autonomous mobile robot.
